(19) United States
(12) Patent Application Publication
(10) Pub. No.: US 2026/0260593 A1
(43) Pub. Date: Sep. 3, 2026

(54) METHOD OF IMAGE DISPLAY ON A DISPLAY PANEL, APPARATUS, DISPLAY APPARATUS, AND COMPUTER-PROGRAM PRODUCT

(71) Applicant: BOE Technology Group Co., Ltd., Beijing (CN)

(72) Inventor: Lei Shao, Beijing (CN)

(73) Assignee: BOE Technology Group Co., Ltd., Beijing (CN)

(21) Appl. No.: 19/659,453

(22) Filed: Apr. 27, 2026

Related U.S. Application Data
(63) Continuation of application No. PCT/CN2024/141686, filed on Dec. 24, 2024.

(51) Int. Cl. G09G 3/20; G06F 3/14; G09G 5/06

(52) U.S. Cl. CPC G09G 3/2003; G06F 3/1407; G09G 5/06; G09G 2320/0686

(57) ABSTRACT

A method includes dividing a display area of the display panel into a plurality of display subareas, a respective display subarea configured to independently display an image; and adding a border to at least one display subarea in the display area. Adding the border to the at least one display subarea in the display area includes retrieving information about at least one display subarea based on coordinates on the display panel; formatting display subarea information; determining coordinates of borders of the at least one display subarea; tagging the coordinates of borders of the at least one display subarea with a tag indicating whether or not the borders of the at least one display subarea is to be displayed; assigning a value to a tag indicating whether or not the border of the at least one display subarea is to be displayed; and displaying an image in the display area.

### CROSS-REFERENCE TO RELATED APPLICATION

This application is a continuation of International Application No. PCT/CN2024/141686, filed Dec. 24, 2024, the contents of which are incorporated by reference in the entirety.

### TECHNICAL FIELD

The present invention relates to display technology, more particularly, to a method of image display on a display panel, an apparatus, a display apparatus, and a computer-program product.

### BACKGROUND

Display technologies have rapidly advanced to support diverse applications, from personal devices to large-scale systems like video walls in command centers, monitoring systems, and advertising. These large-scale displays often consist of multiple spliced panels, enabling flexible configurations to divide the screen into multiple windows with regular or irregular layouts for displaying distinct or integrated content. The growing demand for seamless integration, high visual clarity, and operational flexibility drives innovations in managing display components, optimizing transitions across seams, and tailoring configurations to meet various functional and aesthetic requirements across industries.

### SUMMARY

In one aspect, the present disclosure provides a method of image display on a display panel, comprising dividing a display area of the display panel into a plurality of display subareas, a respective display subarea of the plurality of display subareas configured to independently display an image; and adding a border to at least one display subarea of the plurality of display subareas in the display area; wherein adding the border to the at least one display subarea in the display area comprises retrieving information about at least one display subarea based on coordinates on the display panel; formatting display subarea information; determining coordinates of borders of the at least one display subarea; tagging the coordinates of borders of the at least one display subarea with a tag indicating whether or not the borders of the at least one display subarea is to be displayed; assigning a value to a tag indicating whether or not the border of the at least one display subarea is to be displayed; and displaying an image in the display area.

Optionally, the method further comprises determining a shortest distance between a border of the at least one display subarea and any border of the display area that is parallel to the border of the at least one display subarea; and displaying the border of the at least one display subarea upon determination that the shortest distance between the border of the at least one display subarea and any border of the display area that is parallel to the border of the at least one display subarea is greater than a reference distance.

Optionally, upon determination that the shortest distance between the border of the at least one display subarea and any border of the display area that is parallel to the border of the at least one display subarea is equal to or less than the reference distance, the border of the at least one display subarea is not displayed.

Optionally, assigning the value to the tag indicating whether or not the border of the at least one display subarea is to be displayed includes assigning a first value to the tag indicating that the border of the at least one display subarea is not to be displayed upon determination that the shortest distance between the border of the at least one display subarea and any border of the display area that is parallel to the border of the at least one display subarea is equal to or less than the reference distance; and assigning the value to the tag indicating whether or not the border of the at least one display subarea is to be displayed includes assigning a second value to the tag indicating that the border of the at least one display subarea is to be displayed upon determination that the shortest distance between the border of the at least one display subarea and any border of the display area that is parallel to the border of the at least one display subarea is greater than the reference distance.

Optionally, the display area comprises M rows and N columns of pixels; and the plurality of display subareas comprise a central display subarea spanning from a pixel at an (m+1)-th column and an (n+1)-th row to a pixel at an (M−m)-th column and N-th row, and multiple peripheral display subareas, wherein m, n, M, and N are positive integers, M>m, and N>n.

Optionally, the method further comprises determining a shortest distance between a border of the peripheral display subarea and any border of the central display subarea that is parallel to the border of the peripheral display subarea; and displaying the border of the peripheral display subarea upon determination that the shortest distance between the border of the peripheral display subarea and any border of the central display subarea that is parallel to the border of the peripheral display subarea is greater than a reference distance.

Optionally, upon determination that the shortest distance between a border of the peripheral display subarea and any border of the central display subarea that is parallel to the border of the peripheral display subarea is equal to or less than the reference distance, the border of the peripheral display subarea is not displayed.

Optionally, assigning the value to the tag indicating whether or not the border of the at least one display subarea is to be displayed includes assigning a first value to the tag indicating that the border of the peripheral display subarea is not to be displayed upon determination that the shortest distance between a border of the peripheral display subarea and any border of the central display subarea that is parallel to the border of the peripheral display subarea is equal to or less than the reference distance; and assigning the value to the tag indicating whether or not the border of the at least one display subarea is to be displayed includes assigning a second value to the tag indicating that the border of the peripheral display subarea is to be displayed upon determination that the shortest distance between the border of the peripheral display subarea and any border of the central display subarea that is parallel to the border of the peripheral display subarea is greater than the reference distance.

Optionally, the method further comprises determining a width of a displayed border of the at least one display subarea

Optionally, the width of the displayed border of the at least one display subarea is determined according to:

$$pixels = 2 \times 1.22 \times ( ( colorx \times {10}^{- 9} ) / ( eyed \times 0.001 ) ) \times d \times \frac{\sqrt{{wp}^{2} + {hp}^{2}}}{di \times 0. 0254}$$

wherein pixels stands for a number of pixels that determines the width of the displayed border; colorx stands for a wavelength of the light; eyed stands for a diameter of the human iris; d stands for a distance between the human eye and the display area; wₚstands for a horizontal resolution of the display area; hₚstands for a vertical resolution of the display area; dᵢ stands a length of the diagonal of the display area.

Optionally, the method further comprises rounding up the number of pixels that determines the width of the displayed border to the nearest integer, thereby determining a calculated width of the displayed border.

Optionally, the method further comprises applying the value of the width of the displayed border to the displayed border of the at least one display subarea where a second value is assigned to the tag indicating the border of the at least one display subarea is to be displayed.

Optionally, the method further comprises performing a correction adjustment to a calculated width of the displayed border, thereby obtaining a final width of the displayed border.

Optionally, the method further comprises determining a value of the wavelength of the light used in determining a width of a displayed border of the at least one display subarea; wherein determining the value of the wavelength of the light used in determining the width of the displayed border of the at least one display subarea comprises summing grayscale values of all pixels of each color component within a specified area in the display area to obtain summed grayscale values of each color component; determining a mean value for grayscale values of each color component to obtain mean grayscale values of each color component; inverting the summed grayscale values of each color component based on the mean grayscale values of each color component to obtain inverted grayscale values of each color component; and determining the value of the wavelength of the light used in determining the width of the displayed border of the at least one display subarea based on the inverted grayscale values of each color component.

Optionally, determining the value of the wavelength of the light used in determining the width of the displayed border of the at least one display subarea further comprises setting an inverted grayscale value to 0 if any of the inverted grayscale values of each color component is less than 0; and setting an inverted grayscale value to 255 if any of the inverted grayscale values of each color component is greater than 255.

Optionally, determining the value of the wavelength of the light used in determining the width of the displayed border of the at least one display subarea further comprises using a lookup table including correlations between grayscale values and corresponding wavelengths.

In another aspect, the present disclosure provides an apparatus, comprising a memory; and one or more processors; wherein the memory and the one or more processors are connected with each other; and the memory stores computer-executable instructions for controlling the one or more processors to divide a display area of a display panel into a plurality of display subareas, a respective display subarea of the plurality of display subareas configured to independently display an image; and add a border to at least one display subarea of the plurality of display subareas in the display area; wherein, to add the border to the at least one display subarea in the display area, the memory further stores computer-executable instructions for controlling the one or more processors to retrieve information about at least one display subarea based on coordinates on the display panel; format display subarea information; determine coordinates of borders of the at least one display subarea; tag the coordinates of borders of the at least one display subarea with a tag indicating whether or not the borders of the at least one display subarea is to be displayed; and assign a value to a tag indicating whether or not the border of the at least one display subarea is to be displayed.

In another aspect, the present disclosure provides a display apparatus, comprising the apparatus described herein, and the display panel; wherein the display panel is configured to display an image in the display area and a border of the at least one display subarea.

In another aspect, the present disclosure provides a computer-program product, comprising a non-transitory tangible computer-readable medium having computer-readable instructions thereon, the computer-readable instructions being executable by a processor to cause the processor to perform dividing a display area of the display panel into a plurality of display subareas, a respective display subarea of the plurality of display subareas configured to independently display an image; and adding a border to at least one display subarea of the plurality of display subareas in the display area; wherein adding the border to the at least one display subarea in the display area comprises retrieving information about at least one display subarea based on coordinates on the display panel; formatting display subarea information; determining coordinates of borders of the at least one display subarea; tagging the coordinates of borders of the at least one display subarea with a tag indicating whether or not the borders of the at least one display subarea is to be displayed; and assigning a value to a tag indicating whether or not the border of the at least one display subarea is to be displayed.

### BRIEF DESCRIPTION OF THE FIGURES

The following drawings are merely examples for illustrative purposes according to various disclosed embodiments and are not intended to limit the scope of the present invention.

FIG. 1 is a diagram illustrating the resolving power of an optical instrument.

FIG. 2 illustrates a manner of dividing a display area in some embodiments according to the present disclosure.

FIG. 3 illustrates a manner of dividing a display area in some embodiments according to the present disclosure.

FIG. 4 illustrates a manner of dividing a display area in some embodiments according to the present disclosure.

FIG. 5 is a flowchart illustrating a method of adding a border to at least one display subarea in a display area in a display panel in some embodiments according to the present disclosure.

FIG. 6 is a schematic diagram illustrating the relationship between the human eye's viewing angle, the pixel spacing, and the distance between the human eye and the display area.

FIG. 7 is a schematic diagram illustrating a plurality of display subareas in a display area.

FIG. 8 is a schematic diagram illustrating a plurality of display subareas in a display area in some embodiments according to the present disclosure.

FIG. 9 shows an example of a display area comprising a plurality of display subareas where each of the plurality of display subareas is configured to independently display a respective stream of display information.

FIG. 10 is a schematic diagram illustrating a display area comprising a plurality of display subareas where each of the plurality of display subareas is configured to independently display a respective stream of display information.

FIG. 11 is a schematic diagram illustrating a display area comprising a plurality of display subareas where each of the plurality of display subareas is configured to independently display a respective stream of display information.

FIG. 12 shows an example of a display area comprising a plurality of display subareas where each of the plurality of display subareas is configured to independently display a respective stream of display information.

FIG. 13 is a schematic diagram illustrating a display area comprising a plurality of display subareas where each of the plurality of display subareas is configured to independently display a respective stream of display information.

FIG. 14 is a schematic diagram illustrating a display area comprising a plurality of display subareas where each of the plurality of display subareas is configured to independently display a respective stream of display information.

FIG. 15 shows an example of a display area comprising a plurality of display subareas where each of the plurality of display subareas is configured to independently display a respective stream of display information.

FIG. 16 is a schematic diagram illustrating a display area comprising a plurality of display subareas where each of the plurality of display subareas is configured to independently display a respective stream of display information.

FIG. 17 is a schematic diagram illustrating a display area comprising a plurality of display subareas where each of the plurality of display subareas is configured to independently display a respective stream of display information.

FIG. 18 shows an example of a display area comprising a plurality of display subareas where each of the plurality of display subareas is configured to independently display a respective stream of display information.

FIG. 19 is a schematic diagram illustrating a display area comprising a plurality of display subareas where each of the plurality of display subareas is configured to independently display a respective stream of display information.

FIG. 20 is a schematic diagram illustrating a display area comprising a plurality of display subareas where each of the plurality of display subareas is configured to independently display a respective stream of display information.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

When observing Fraunhofer diffraction through an experimental setup for a single slit, replacing the slit with a small circular aperture produces a diffraction pattern on the screen. At the center, a bright circular spot, known as an Airy disk, is visible. The diffraction angle of the first dark fringe satisfies the following equation:

$$sin θ 1 = 0.61 \frac{λ}{r} = 1.22 \times \frac{λ}{d} ;$$

wherein r and d represent the radius and diameter of the circular aperture, respectively. This equation corresponds to the condition for the first order dark fringe in single-slit diffraction, with a factor of 1.22 accounting for the geometric shape. The angular radius of the Airy disk corresponds to the diffraction angle of the first dark ring.

$$θ 1 \approx sin θ 1 = 0.61 \frac{λ}{r} = 1.22 \times \frac{λ}{d} .$$

If the focal length of a lens is f, the radius of the Airy disk can be calculated as:

$$R = f \times tan θ1 .$$

Because λ is very small, tan θ1≈sin θ1≈θ1, the diffraction effect becomes more significant as d decreases or λ increases. When

$$\frac{λ}{d} ≪ 1 ,$$

the diffraction effect can be neglected.

Angular resolution refers to the capability of an imaging system or its components to distinguish two adjacent objects. It is defined as the smallest angle between two resolvable points. Typically expressed in radians, angular resolution is also referred to as resolving power.

Resolving power can be represented in terms of line pairs per millimeter (lp/mm), and there is a convertible relationship between angular resolution (milliradians) and resolving power (lp/mm) under specific conditions.

When evaluating the imaging capabilities of optical instruments, geometric optics suggests that increasing magnification by adjusting lens focal lengths and combining lenses can make small or distant objects appear clear. However, in practice, diffraction imposes a fundamental limitation on image clarity. Regardless of magnification, the ability of an optical instrument to resolve fine details is capped by this diffraction limit.

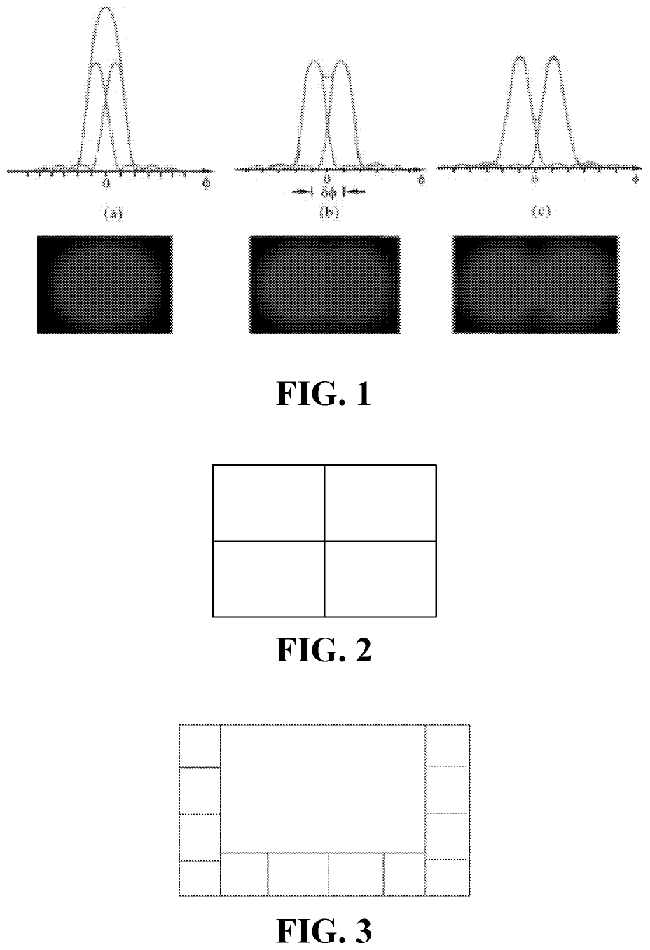

FIG. 1 is a diagram illustrating the resolving power of an optical instrument. For an optical instrument, if the brightest central point of the diffraction pattern from one point light source coincides with the first dark fringe of the diffraction pattern from another point light source (as shown in FIG. 1, the graph denoted as (b)), the light intensity in the overlapping region is approximately 80% of the central maximum intensity of a single diffraction pattern. At this point, the human eye can barely distinguish the two light points as separate images. This condition is referred to as the two point light sources being just resolved by the optical instrument.

The graph denoted as (a) in FIG. 1 illustrates the diffraction pattern produced by a single point light source through an optical system. The pattern consists of a bright central region, known as the central maximum, surrounded by alternating dark and bright rings caused by diffraction. The central maximum is the brightest part of the pattern and is essential for determining the resolving power of the optical system.

The graph denoted as (b) in FIG. 1 depicts two overlapping diffraction patterns from two closely spaced point light sources that are just resolved according to the Rayleigh criterion. The central maximum of one diffraction pattern coincides with the first dark fringe of the other. This overlap results in an intensity of approximately 80% at the midpoint between the two peaks, allowing the human eye to distinguish the two light sources as separate entities.

The graph denoted as (c) in FIG. 1 shows two diffraction patterns from point light sources further separated than in (b), resulting in a more pronounced dip between the peaks. The separation exceeds the Rayleigh criterion, making the two light sources more easily distinguishable.

This condition is known as the Rayleigh criterion. According to this principle, the distance between two points can be determined as the minimum resolvable distance by an optical instrument. Taking a circular aperture lens (or objective lens) as an example, the distance between the centers of the diffraction patterns of two “just resolved” point sources is equal to the radius of the Airy disk. At this point, the angle subtended by the two point sources at the lens is called the minimum resolvable angle. For a diffraction pattern of a circular aperture with diameter d, the angular radius of the Airy disk is given by the following formula:

$$sin θ 1 = 1.22 \times \frac{λ}{d} .$$

Thus, the size of the minimum resolvable angle θ_{R} can be expressed using the following formula:

$${θ}_{R} = θ 1 = 1.22 \times \frac{λ}{d} .$$

This indicates that the minimum resolvable angle is determined by the aperture size d and the wavelength of the light λ. In optical systems, the reciprocal of the minimum resolvable angle is commonly referred to as the resolving power (or resolution) of the instrument. The resolving power of an optical instrument is directly proportional to the aperture size and inversely proportional to the wavelength of the light used.

According to the Rayleigh criterion, the theoretical angular resolution limit of the human eye is given by:

$$θ \approx sin θ = 1.22 \times \frac{λ}{d} = 1.22 \times \frac{555 nm}{5 mm} = 0 ;$$

wherein d is the diameter of the human iris (approximately 5 mm), and λ is the wavelength of light. For visible light, specifically green light at 555 nm, which the human eye is most sensitive to, this formula applies.

Under normal conditions, due to inherent imperfections in the distribution of photoreceptor cells in the retina, achieving an angular resolution of 1 arcminute (1/60°) is challenging. This requires ideal conditions, such as sufficient brightness (e.g., a clear sunny day), high contrast (e.g., black text on white paper), no surface reflections, and exceptionally good vision. In an ideal scenario, the smallest detail the human eye can resolve corresponds to approximately 0.6 arcminutes.

Light is essentially an electromagnetic wave characterized by two key properties: wavelength and intensity. Different wavelengths of light correspond to different colors. Understanding the relationship between wavelength and color is crucial for identifying and analyzing spectra in the future. The wavelength of light is measured in nanometers (nm), which is equal to one-billionth of a meter.

Light visible to the human eye is limited; human eyes cannot perceive all types of light. The light that the human eye can detect is called visible light, which is the portion of the electromagnetic spectrum perceptible to human vision. The range of visible light is not precisely defined, but the average human eye can typically detect electromagnetic waves with wavelengths between 400 nm and 700 nm. Some individuals may be able to perceive wavelengths extending from approximately 380 nm to 780 nm. Different wavelengths within this range correspond to different colors perceived by the human eye. The colors of visible light, arranged from longest to shortest wavelength, are: red, orange, yellow, green, blue, indigo, and violet.

In various practical applications, such as command centers and monitoring systems, there is a growing demand for large-scale displays. These include OLED, MiniLED, 110-inch LCDs, and spliced LCD screens. With continuous advancements in display technology, seamless splicing screens have emerged as the leading solution for large-format display requirements.

To meet operational needs, seamless splicing screens often require the division of the display area into multiple display subareas for presenting distinct content. However, when these display subareas lack defined borders and their displayed content features similar colors, users may struggle to differentiate between display subareas. Overlapping display subareas further complicate the visual distinction, making it difficult to correlate images with their corresponding display subareas. This absence of a structured display subarea layout negatively impacts the user experience.

Accordingly, the present disclosure provides, inter alia, a method of image display on a display panel, an apparatus, a display apparatus, and a computer-program product that substantially obviate one or more of the problems due to limitations and disadvantages of the related art. In one aspect, the present disclosure provides a method of image display on a display panel. In some embodiments, the method includes dividing a display area of the display panel into a plurality of display subareas, a respective display subarea of the plurality of display subareas configured to independently display an image; and adding a border to at least one display subarea of the plurality of display subareas in the display area. Optionally, adding the border to the at least one display subarea in the display area comprises retrieving information about at least one display subarea based on coordinates on the display panel; formatting display subarea information; determining coordinates of borders of the at least one display subarea; tagging the coordinates of borders of the at least one display subarea with a tag indicating whether or not the borders of the at least one display subarea is to be displayed; assigning a value to a tag indicating whether or not the border of the at least one display subarea is to be displayed; and displaying an image in the display area.

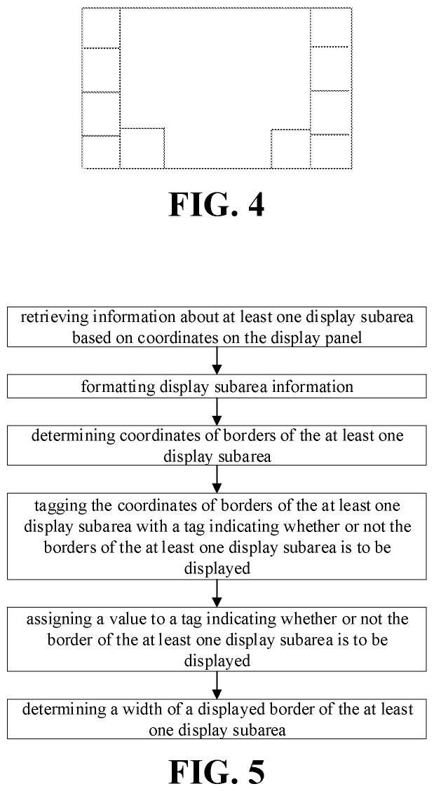

FIG. 2 illustrates a manner of dividing a display area in some embodiments according to the present disclosure. FIG. 3 illustrates a manner of dividing a display area in some embodiments according to the present disclosure. FIG. 4 illustrates a manner of dividing a display area in some embodiments according to the present disclosure. In ultra-large screen displays, the entire display area can be divided into multiple distinct display subareas. The division of display subareas can be regular, such as a 2-row×2-column grid (as shown in FIG. 2). Alternatively, the division can be irregular, as illustrated in FIG. 3 and FIG. 4.

Various appropriate rules for display subarea division may be implemented, the layout varies depending on specific business requirements.

In one aspect, the present disclosure provides a method of adding a border to at least one display subarea in the display area. FIG. 5 is a flowchart illustrating a method of adding a border to at least one display subarea in a display area in a display panel in some embodiments according to the present disclosure. Referring to FIG. 5, the method in some embodiments includes retrieving information about at least one display subarea based on coordinates on the display panel; and formatting display subarea information.

In one particular example, retrieving information about one or more display subareas are performed sequentially from left to right. In one example, formatting display subarea information includes formatting display subarea information using a first corner coordinate (x, y), a display subarea width, and a display subarea height. In one example, the formatted result is represented as {(x, y), Width, Height}, wherein (x, y) stands for the first corner coordinate; Width stands for the display subarea width, and Height stands for the display subarea height.

In some embodiments, the method further includes determining coordinates of borders of the at least one display subarea. Optionally, determining coordinates of borders of the at least one display subarea includes determining the coordinates of borders of the at least one display subarea using the first corner coordinate (x, y), the display subarea width, and the display subarea height.

In some embodiments, the method further includes tagging the coordinates of borders of the at least one display subarea with a tag indicating whether or not the borders of the at least one display subarea is to be displayed. A true value indicates that a border is to be displayed. A false value indicates that a border is not to be displayed.

In one example, a result of formatting display subarea information is below:

```
  Window {
  Top-left coordinates (x, y), Width, Height,
  Left border: { Start coordinates (x, y), End coordinates (x, y + Height),
isShowBorder: true or false }
  Right border: { Start coordinates (x + Width, y), End coordinates (x + Width, y +
Height), isShowBorder: true or false }
  Top border: { Start coordinates (x, y), End coordinates (x + Width, y),
isShowBorder: true or false }
  Bottom border: { Start coordinates (x, y + Height), End coordinates (x + Width, y +
Height), isShowBorder: true or false }
  }
```

The parameter “isShowBorder” stands for the tag indicating whether or not the borders of the at least one display subarea is to be displayed.

In some embodiments, the method further includes determining a shortest distance between a border of the at least one display subarea and a border of the display area that is parallel to the border of the at least one display subarea. As used herein, the term parallel means an angle between the two borders is less than 10 degrees, e.g., less than 9 degrees, less than 8 degrees, less than 7 degrees, less than 6 degrees, less than 5 degrees, less than 4 degrees, less than 3 degrees, less than 2 degrees, or less than 1 degree. In one example, determining the shortest distance between the border of the at least one display subarea and the border of the display area that is parallel to the border of the at least one display subarea is performed based on the coordinates of borders of the at least one display subarea and coordinates of borders of the display area.

In some embodiments, the method further includes assigning a value to a tag indicating whether or not the border of the at least one display subarea is to be displayed. In some embodiments, assigning the value to the tag includes determining whether or not the shortest distance between the border of the at least one display subarea and the border of the display area that is parallel to the border of the at least one display subarea is greater than a reference distance. Optionally, the method further includes assigning a first value (e.g., a false value) to the tag indicating the border of the at least one display subarea is not to be displayed, upon determination that the shortest distance is equal to or less than the reference distance (e.g., the border of the at least one display subarea is identified as adjacent to the border of the display area that is parallel to the border of the at least one display subarea). Optionally, the method further includes assigning a second value (e.g., a true value) to the tag indicating the border of the at least one display subarea is to be displayed, upon determination that the shortest distance is greater than the reference distance (e.g., the border of the at least one display subarea is identified as away from the border of the display area that is parallel to the border of the at least one display subarea). In one example, the reference distance may be 10 pixels, 20 pixels, 30 pixels, 40 pixels, or 50 pixels.

In some embodiments, the method further includes determining a width of a displayed border of the at least one display subarea. If the width of the displayed border is too large, they will occupy excessive display space, reducing the usable area. Conversely, if the width of the displayed border is too small, they may not be visible to the human eye, failing to achieve a clear delineation of the display subarea boundaries.

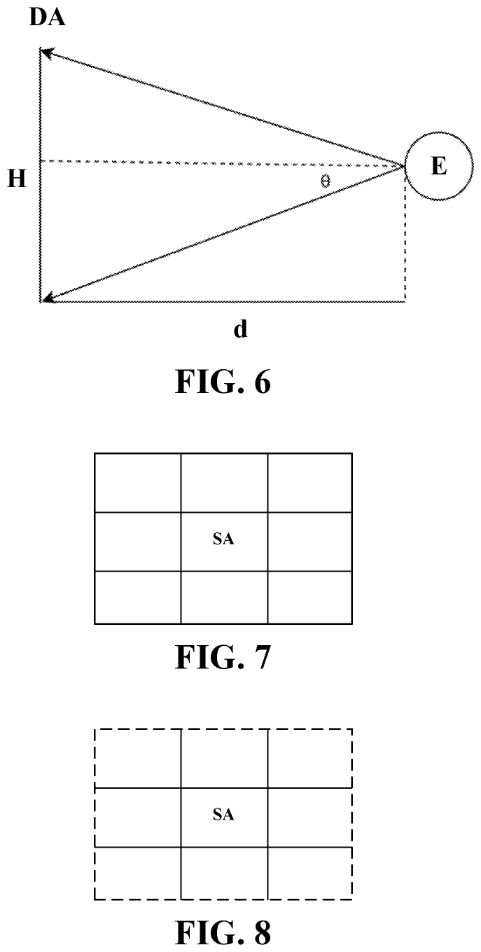

FIG. 6 is a schematic diagram illustrating the relationship between the human eye's viewing angle, the pixel spacing, and the distance between the human eye and the display area. In FIG. 6, H denotes the pixel spacing, θ denotes the human eye's viewing angle, d denotes the distance between the human eye E and the display area DA.

The human eye, at a specific distance and viewing angle, can resolve the radius of the distance between two pixels on a display area. The formula is as follows:

h=d×tan θ, wherein h stands for a radius of the distance between two distinguishable pixels, and d stands for a distance between the human eye E and the display area DA.

Based on the Fraunhofer diffraction of a circular aperture, the Rayleigh criterion, and the principles of visible light color and wavelength, let the wavelength of the light be denoted as “colorx” (in nanometers) and the diameter of the human iris as “eyed” (in millimeters). The theoretical limit of the human eye's angular resolution is given by:

$$θ = sin θ = 1.22 \times \frac{c o l o rx \times {10}^{- 9}}{e y e d \times 0.001} .$$

Here, sin θ represents the angular resolution of the human eye. One arcminute is equal to 1/(60 degrees), and since 180 degrees=π, 1 arcminute equals π/180/60=0.000291 radians.

From the Fraunhofer diffraction of a circular aperture:

$$θ = sin θ = tan θ = \frac{h}{d} = 1.22 \times \frac{c o l o rx \times {10}^{- 9}}{e y e d \times 0.001} .$$

Rearranging to solve for h:

$$h = 1.22 \times \frac{c o l o r x \times 1 {0}^{- 9}}{e y e d \times 0.001} \times d ;$$

wherein h stands for a radius of the distance between two distinguishable pixels, and d stands for a distance between the human eye E and the display area DA. A total distance between two distinguishable pixels visible to the human eye can be represented as 2 h.

The pixel density, or Pixels Per Inch (PPI), can be calculated to according to:

$$PPI = \frac{{d}_{p}}{{d}_{i}} = \frac{\sqrt{{w}_{p}^{2} + {h}_{p}^{2}}}{{d}_{i}} ;$$

wherein dₚ stands for a resolution of the display area DA along the diagonal (in pixels); wₚ stands for a horizontal resolution of the display area DA (number of pixels along the width); hₚ stands for a vertical resolution of the display area DA (number of pixels along the height); dᵢ stands a length of the diagonal of the display area DA (e.g., in inches).

Based on the above calculations, combined with practical scenarios, the human eye's resolution can be determined. Assuming the human eye's angular resolution is normal (set to 1 arcminute) and the distance between the eye and the display area is constant, along with fixed screen dimensions and resolution, the number of distinguishable pixels at the given distance can be calculated. This pixel count corresponds to the width of the width of the displayed border.

$$pixels = 2 \times 1.22 \times ( ( colorx \times {10}^{- 9} ) / ( eyed \times 0.001 ) ) \times d \times \frac{\sqrt{w {p}^{2} + h {p}^{2}}}{d i \times 0.0254} ;$$

wherein pixels stands for a number of pixels that determines the width of the displayed border; colorx stands for a wavelength of the light (e.g., in nanometers); eyed stands for a diameter of the human iris (e.g., in millimeters); d stands for a distance between the human eye and the display area (e.g., in meters); wₚ stands for a horizontal resolution of the display area DA (number of pixels along the width); hₚ stands for a vertical resolution of the display area DA (number of pixels along the height); dᵢ stands a length of the diagonal of the display area DA (e.g., in inches). In the above equation, 0.0254 stands for a conversion factor from inches to meters.

In some embodiments, the method further includes rounding up the number of pixels that determines the width of the displayed border to the nearest integer, ensuring it is a whole number; thereby determining a value of the width of the displayed border. In some embodiments, the method further includes applying the value of the width of the displayed border to the displayed border of the at least one display subarea where a second value is assigned to a tag indicating the border of the at least one display subarea is to be displayed. The border's length is defined by the distance between its start and end points. In some embodiments, the method further includes setting a color of the displayed border, e.g., setting the color of the displayed border to match the value of colorx.

In some embodiments, the method further includes performing a correction adjustment to a calculated width of the displayed border, thereby obtaining a final width of the displayed border. In one example, the correction adjustment is performed according to:

$$EndPixels = {pixels}^{′} + x ;$$

wherein EndPixels stands for the final width of the displayed border; pixels' stands for the number of pixels that determines the width of the displayed border rounded up to the nearest integer; x stands for a correction variable, representing the number of pixels to be added (+x) or subtracted (−x) to adjust the border width.

In one example, the wavelength of the light is 555 nanometers (green light). The distance between the human eye and the display area is 5 meters, and the diameter of the human iris is 5 millimeters. The display area has 3840 horizontal pixels and 2160 vertical pixels, with a diagonal size of 110 inches. The human eye can distinguish two pixels at a distance of 0.0013542 meters, resulting in a calculated border width of 2 pixels.

The pixel spacing H, which is the distance between two distinguishable pixels as perceived by the human eye, may be calculated as follows:

$$H = 2 \times 1.22 \times ( ( colorx \times {10}^{- 9} ) / ( eyed \times 0.001 ) ) \times d ;$$

wherein H stands for the distance between two distinguishable pixels as perceived by the human eye, colorx stands for a wavelength of the light (e.g., in nanometers); eyed stands for a diameter of the human iris (e.g., in millimeters); and d stands for a distance between the human eye and the display area (e.g., in meters).

The pixel density can be calculated using the following formula:

$$PPI = \frac{{d}_{p}}{{d}_{i}} = \frac{\sqrt{{w}_{p}^{2} + {h}_{p}^{2}}}{{d}_{i} \times 0.0254} ;$$

wherein dₚ stands for a resolution of the display area DA along the diagonal (in pixels); wₚ stands for a horizontal resolution of the display area DA (number of pixels along the width); hₚ stands for a vertical resolution of the display area DA (number of pixels along the height); dᵢ stands a length of the diagonal of the display area DA (e.g., in inches).

In one example, wₚ is 3840, hₚ is 2160, dᵢ is 110 inches, and PPI is 1576 pixels per meter.

Using the pixel density PPI of 1576 pixels per meter and the distance between two distinguishable pixels as perceived by the human eye of 0.0013542 meters, the number of pixels that determines the width of the displayed border is 1576×0.0013542=2. The width of the display subarea is 2 pixels.

FIG. 7 is a schematic diagram illustrating a plurality of display subareas in a display area in a related display panel. Referring to FIG. 7, the display area includes a plurality of display subareas SA. All borders of each display subarea are displayed.

FIG. 8 is a schematic diagram illustrating a plurality of display subareas in a display area in some embodiments according to the present disclosure. Referring to FIG. 8, with respect to a display subarea, if the shortest distance between a border of the at least one display subarea and any border of the display area that is parallel to the border of the at least one display subarea is equal to or less than the reference distance (e.g., the border of the at least one display subarea is identified as adjacent to the border of the display area that is parallel to the border of the at least one display subarea), the border of the at least one display subarea is not displayed. With respect to a display subarea, if the shortest distance between a border of the at least one display subarea and any border of the display area that is parallel to the border of the at least one display subarea is greater than the reference distance (e.g., the border of the at least one display subarea is identified as away from the border of the display area that is parallel to the border of the at least one display subarea), the border of the at least one display subarea is displayed. In FIG. 8, all borders of a central display subarea is displayed. A border of any display subarea that is adjacent to a border of the display area is not displayed.

Based on the actual processed display subarea effects, the border effects can be further fine-tuned by adjusting the border width. This adjustment ensures the optimal visual experience and precision. The final outcome represents the refined border effect after this adjustment.

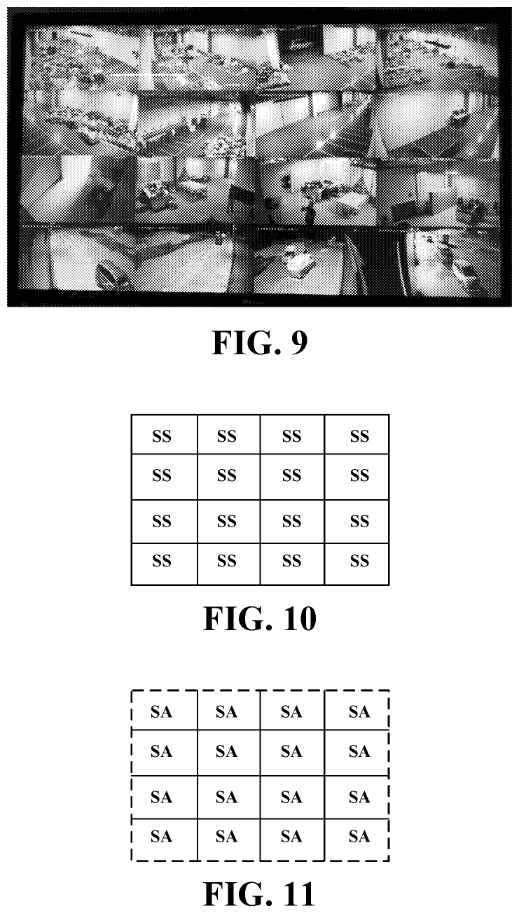

In some embodiments, each of the plurality of display subareas is configured to independently display a respective stream of display information. FIG. 9 shows an example of a display area comprising a plurality of display subareas where each of the plurality of display subareas is configured to independently display a respective stream of display information.

FIG. 10 is a schematic diagram illustrating a display area comprising a plurality of display subareas where each of the plurality of display subareas is configured to independently display a respective stream of display information. Referring to FIG. 9 and FIG. 10, the display area in some embodiments is configured to receive a plurality of signal sources SS. Each of the plurality of display subareas SA is configured to independently receive a respective signal source of the plurality of signal sources SS, and independently display a respective stream of display information based on the respective signal source.

In one example, the wavelength of the light is 450 nanometers (blue light). The distance between the human eye and the display area is 5 meters, and the diameter of the human iris is 5 millimeters. The display area has 1920 horizontal pixels and 1080 vertical pixels, with a diagonal size of 55 inches. The human eye can distinguish two pixels at a distance of 0.001098 meters, resulting in a calculated border width of 2 pixels.

The pixel spacing H, which is the distance between two distinguishable pixels as perceived by the human eye, may be calculated as follows:

$$H = 2 \times 1.22 \times ( ( colorx \times {10}^{- 9} ) / ( eyed \times 0.001 ) ) \times d ;$$

wherein H stands for the distance between two distinguishable pixels as perceived by the human eye, colorx stands for a wavelength of the light (e.g., in nanometers); eyed stands for a diameter of the human iris (e.g., in millimeters); and d stands for a distance between the human eye and the display area (e.g., in meters).

The pixel density can be calculated using the following formula:

$$PPI = \frac{{d}_{p}}{{d}_{i}} = \frac{\sqrt{{w}_{p}^{2} + {h}_{p}^{2}}}{{d}_{i} \times 0.0254} ;$$

wherein dₚ stands for a resolution of the display area DA along the diagonal (in pixels); wₚ stands for a horizontal resolution of the display area DA (number of pixels along the width); hₚ stands for a vertical resolution of the display area DA (number of pixels along the height); dᵢ stands a length of the diagonal of the display area DA (e.g., in inches).

In one example, wₚ is 1920, hₚ is 1080, dᵢ is 55 inches, and PPI is 1920 pixels per meter.

Using the pixel density PPI of 1920 pixels per meter and the distance between two distinguishable pixels as perceived by the human eye of 0.001098 meters, the number of pixels that determines the width of the displayed border is 1920×0.001098=2. The width of the display subarea is 2 pixels.

FIG. 11 is a schematic diagram illustrating a display area comprising a plurality of display subareas where each of the plurality of display subareas is configured to independently display a respective stream of display information. Referring to FIG. 11, with respect to a display subarea, if the shortest distance between a border of the at least one display subarea and any border of the display area that is parallel to the border of the at least one display subarea is equal to or less than the reference distance (e.g., the border of the at least one display subarea is identified as adjacent to the border of the display area that is parallel to the border of the at least one display subarea), the border of the at least one display subarea is not displayed. With respect to a display subarea, if the shortest distance between a border of the at least one display subarea and any border of the display area that is parallel to the border of the at least one display subarea is greater than the reference distance (e.g., the border of the at least one display subarea is identified as away from the border of the display area that is parallel to the border of the at least one display subarea), the border of the at least one display subarea is displayed. In FIG. 11, all borders of a central display subarea is displayed. A border of any display subarea that is adjacent to a border of the display area is not displayed.

Based on the actual processed display subarea effects, the border effects can be further fine-tuned by adjusting the border width. This adjustment ensures the optimal visual experience and precision. The final outcome represents the refined border effect after this adjustment.

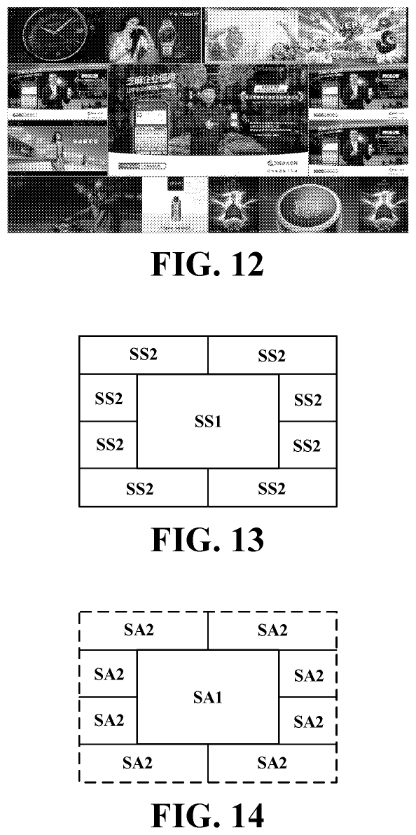

In some embodiments, each of the plurality of display subareas is configured to independently display a respective stream of display information. In some embodiments, the display area includes M rows and N columns of pixels. A margin of n rows of pixels at the top, a margin of n rows of pixels at the bottom, a margin of m columns of pixels at the left, and a margin of m columns of pixels at the right, are reserved for multiple peripheral subareas configured to independently display respective streams of display information. A central display subarea, spanning from a pixel at an (m+1)-th column and an (n+1)-th row to a pixel at an (M−m)-th column and (N-n)-th row, is spliced together into a unified central display subarea; wherein m, n, M, and N are positive integers, M>m, and N>n. FIG. 12 shows an example of a display area comprising a plurality of display subareas where each of the plurality of display subareas is configured to independently display a respective stream of display information. Referring to FIG. 12, the display area includes a central display subarea and multiple peripheral display subareas surrounding the central display subarea on all four sides.

FIG. 13 is a schematic diagram illustrating a display area comprising a plurality of display subareas where each of the plurality of display subareas is configured to independently display a respective stream of display information. In some embodiments, the display area is configured to receive a plurality of signal sources. Each of the plurality of display subareas is configured to independently receive a respective signal source of the plurality of signal sources, and independently display a respective stream of display information based on the respective signal source. Referring to FIG. 12 and FIG. 13, the central display subarea is configured to receive a first signal source SS1, and the multiple peripheral display subareas are configured to receive multiple second signal sources SS2, respectively. The central display subarea is configured to display a first stream of display information based on the first signal source SS1. Each of the multiple second display subareas is configured to independently receive a respective second signal source of the multiple second signal sources SS2, and independently display a respective second stream of display information based on the respective second signal source.

In one example, the wavelength of the light is denoted as colorx. The distance between the human eye and the display area is 8 meters, and the diameter of the human iris is 5 millimeters. The display area has 1920 horizontal pixels and 1080 vertical pixels, with a diagonal size of 120 inches. The human eye can distinguish two pixels at a distance of 0.00242048 meters, resulting in a calculated border width of 2 pixels.

In another example, XWidth is defined as a variable value used to specify the width of pixels for each window in both horizontal and vertical directions. The following calculations are performed. Grayscale values of all pixels of a same color within the specified area are summed for each color component:

$${R}_{C ount} = {\sum }_{c ount}^{1} R ;$$

$${G}_{C ount} = {\sum }_{c ount}^{1} G ;$$

$${B}_{C ount} = {\sum }_{c ount}^{1} B .$$

The mean value for each color component is calculated:

$${R}_{m e a n} = {R}_{C ount} / Count ;$$

$${G}_{m e a n} = {G}_{C ount} / Count ;$$

$${B}_{m e a n} = {B}_{C ount} / Count .$$

The summed grayscale value for each color component is inverted based on a respective mean value:

$${R}_{r e sult} = ⌊ 255 - {R}_{m e a n} \vert ;$$

$${G}_{r e sult} = ⌊ 255 - {G}_{m e a n} \vert ;$$

$${B}_{r e sult} = ⌊ 255 - {B}_{m e a n} \vert .$$

Based on the values of Rᵣₑₛᵤₗₜ, Gᵣₑₛᵤₗₜ, and Bᵣₑₛᵤₗₜ, ranges of the grayscale values of each color component can be determined.

If any of the values of Rᵣₑₛᵤₗₜ, Gᵣₑₛᵤₗₜ, and Bᵣₑₛᵤₗₜ is less than 0, then set the final value to 0.

$${R}_{f i n a l} = max ( 0 , {R}_{r e sult} ) ;$$

$${G}_{f i n a l} = max ( 0 , {G}_{r e sult} ) ;$$

$${B}_{f i n a l} = max ( 0 , {B}_{r e sult} ) .$$

If any of the values of Rᵣₑₛᵤₗₜ, Gᵣₑₛᵤₗₜ, and Bᵣₑₛᵤₗₜ is greater than 255, then set the final value to 255.

$${R}_{f i n a l} = min ( 2 \; 55 , {R}_{r e sult} ) ;$$

$${G}_{f i n a l} = min ( 255 , {G}_{r e sult} ) ;$$

$${B}_{f i n a l} = min ( 255 , {B}_{r e sult} ) .$$

R_{final}, G_{final}, and B_{final} are the adjusted values for the red, green, and blue components, ensuring they remain within the valid range of 0 to 255.

A lookup table is pre-defined to create a mapping between grayscale values and corresponding wavelengths. Using this lookup table, the wavelength for the desired color can be determined. In this example, the lookup table identifies the current color as yellow, with a wavelength of 620 nm. Therefore, colorx is 620 nm.

The pixel spacing H, which is the distance between two distinguishable pixels as perceived by the human eye, may be calculated as follows:

$$H = 2 \times 1.22 \times ( ( colors \times {10}^{- 9} ) / ( eyed \times 0.001 ) ) \times d ;$$

wherein H stands for the distance between two distinguishable pixels as perceived by the human eye, colorx stands for a wavelength of the light (e.g., in nanometers); eyed stands for a diameter of the human iris (e.g., in millimeters); and d stands for a distance between the human eye and the display area (e.g., in meters).

In one example, colorx is 620 nm, and His 0.00242048 meters.

The pixel density can be calculated using the following formula:

$$PPI = \frac{{d}_{p}}{{d}_{i}} = \frac{\sqrt{{w}_{p}^{2} + {h}_{p}^{2}}}{{d}_{i} \times 0.0254} ;$$

wherein dₚ stands for a resolution of the display area DA along the diagonal (in pixels); wₚ stands for a horizontal resolution of the display area DA (number of pixels along the width); hₚ stands for a vertical resolution of the display area DA (number of pixels along the height); dᵢ stands a length of the diagonal of the display area DA (e.g., in inches).

In one example, wₚ is 1920, hₚ is 1080, dᵢ is 120 inches, and PPI is 722 pixels per meter.

Using the pixel density PPI of 722 pixels per meter and the distance between two distinguishable pixels as perceived by the human eye of 0.00242048 meters, the number of pixels that determines the width of the displayed border is 722×0.00242048=2. The width of the display subarea is 2 pixels.

FIG. 14 is a schematic diagram illustrating a display area comprising a plurality of display subareas where each of the plurality of display subareas is configured to independently display a respective stream of display information. Referring to FIG. 14, with respect to a display subarea, if the shortest distance between a border of the at least one display subarea and any border of the display area that is parallel to the border of the at least one display subarea is equal to or less than the reference distance (e.g., the border of the at least one display subarea is identified as adjacent to the border of the display area that is parallel to the border of the at least one display subarea), the border of the at least one display subarea is not displayed. With respect to a display subarea, if the shortest distance between a border of the at least one display subarea and any border of the display area that is parallel to the border of the at least one display subarea is greater than the reference distance (e.g., the border of the at least one display subarea is identified as away from the border of the display area that is parallel to the border of the at least one display subarea), the border of the at least one display subarea is displayed. In FIG. 14, all borders of a central display subarea is displayed. A border of any peripheral display subarea that is adjacent to a border of the display area is not displayed.

Based on the actual processed display subarea effects, the border effects can be further fine-tuned by adjusting the border width. This adjustment ensures the optimal visual experience and precision. The final outcome represents the refined border effect after this adjustment.

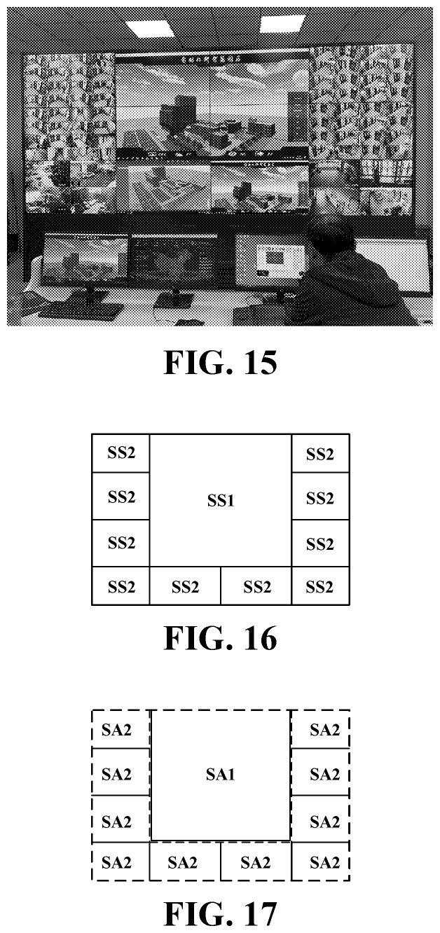

In some embodiments, each of the plurality of display subareas is configured to independently display a respective stream of display information. In some embodiments, the display area includes M rows and N columns of pixels. A margin of n rows of pixels at the bottom, a margin of m columns of pixels at the left, and a margin of m columns of pixels at the right, are reserved for multiple peripheral subareas configured to independently display respective streams of display information. A central display subarea, spanning from a pixel at an (m+1)-th column and an (n+1)-th row to a pixel at an (M−m)-th column and N-th row, is spliced together into a unified central display subarea; wherein m, n, M, and N are positive integers, M>m, and N>n. FIG. 15 shows an example of a display area comprising a plurality of display subareas where each of the plurality of display subareas is configured to independently display a respective stream of display information. Referring to FIG. 15, the display area includes a central display subarea and multiple peripheral display subareas surrounding the central display subarea on three sides but not on the other side.

FIG. 16 is a schematic diagram illustrating a display area comprising a plurality of display subareas where each of the plurality of display subareas is configured to independently display a respective stream of display information. In some embodiments, the display area is configured to receive a plurality of signal sources. Each of the plurality of display subareas is configured to independently receive a respective signal source of the plurality of signal sources, and independently display a respective stream of display information based on the respective signal source. Referring to FIG. 15 and FIG. 16, the central display subarea is configured to receive a first signal source SS1, and the multiple peripheral display subareas are configured to receive multiple second signal sources SS2, respectively. The central display subarea is configured to display a first stream of display information based on the first signal source SS1. Each of the multiple second display subareas is configured to independently receive a respective second signal source of the multiple second signal sources SS2, and independently display a respective second stream of display information based on the respective second signal source.

In one example, the wavelength of the light is 450 nanometers (blue light). The distance between the human eye and the display area is 5 meters, and the diameter of the human iris is 5 millimeters. The display area has 1920 horizontal pixels and 1080 vertical pixels, with a diagonal size of 55 inches. The human eye can distinguish two pixels at a distance of 0.001098 meters, resulting in a calculated border width of 2 pixels.

Since the screen resolution and screen size are fixed, information for all windows is retrieved sequentially from left to right based on screen coordinates. The display subarea information is formatted with the following parameters:
Top-left coordinates (x, y): Specifies the position of the display subarea's top-left corner;
Width (Width): Specifies the horizontal size of the display subarea;
Height (Height): Specifies the vertical size of the window.

The formatted result for a respective display subarea is as follows:
Window {Top-left coordinates (x, y), Width (Width), Height (Height)}

Based on the Top-left coordinates (x, y), Width (Width), Height (Height), the start and end coordinates of all borders of the respective display subarea can be determined. Additionally, a parameter “isShowBorder” is included. The parameter “isShowBorder” stands for the tag indicating whether or not the borders of the at least one display subarea is to be displayed. A true value assigned to the parameter “isShowBorder” indicates that the border should be displayed. A false value assigned to the parameter “isShowBorder” indicates that the border should not be displayed.

In one example, a result of formatting display subarea information is below:

```
  Window
  Top-left coordinates (x, y), Width, Height,
  Left border: { Start coordinates (x, y), End coordinates (x, y + Height),
isShowBorder: true or false }
  Right border: { Start coordinates (x + Width, y), End coordinates (x + Width, y +
Height), isShowBorder: true or false }
  Top border: { Start coordinates (x, y), End coordinates (x + Width, y),
isShowBorder: true or false }
  Bottom border: { Start coordinates (x, y + Height), End coordinates (x + Width, y +
Height), isShowBorder: true or false }
  }
```

Subsequently, a shortest distance between a border of the at least one display subarea and a border of the display area that is parallel to the border of the at least one display subarea is determined. In one example, determining the shortest distance between the border of the at least one display subarea and the border of the display area that is parallel to the border of the at least one display subarea is performed based on the coordinates of borders of the at least one display subarea and coordinates of borders of the display area.

In some embodiments, a value (e.g., true or false) is assigned to a tag (e.g., isShowBorder) indicating whether or not the border of the at least one display subarea is to be displayed. In some embodiments, assigning the value to the tag includes determining whether or not the shortest distance between the border of the at least one display subarea and the border of the display area that is parallel to the border of the at least one display subarea is greater than a reference distance. Optionally, the method further includes assigning a first value (e.g., a false value) to the tag indicating the border of the at least one display subarea is not to be displayed, upon determination that the shortest distance is equal to or less than the reference distance (e.g., the border of the at least one display subarea is identified as adjacent to the border of the display area that is parallel to the border of the at least one display subarea). Optionally, the method further includes assigning a second value (e.g., a true value) to the tag indicating the border of the at least one display subarea is to be displayed, upon determination that the shortest distance is greater than the reference distance (e.g., the border of the at least one display subarea is identified as away from the border of the display area that is parallel to the border of the at least one display subarea). In one example, the reference distance may be 10 pixels, 20 pixels, 30 pixels, 40 pixels, or 50 pixels.

Because the central display subarea is the largest, the border coordinates of the central display subarea can be determined using the above process. Borders of the multiple peripheral display subareas are traversed to determine if any border of the multiple peripheral display subareas is abutting the central display subarea. Upon determination that a border of the multiple peripheral display subareas is abutting the central display subarea, a first value (e.g., a false value) is assigned to the tag indicating the border of the multiple peripheral display subareas is not to be displayed. The inventors of the present disclosure discover that this ensures that no borders are displayed if they are directly adjacent to the central display subarea, creating a seamless visual effect between the central display subarea and adjacent peripheral display subareas.

The pixel spacing H, which is the distance between two distinguishable pixels as perceived by the human eye, may be calculated as follows:

$$H = 2 \times 1.22 \times ( ( colors \times {10}^{- 9} ) / ( eyed \times 0.001 ) ) \times d ;$$

wherein H stands for the distance between two distinguishable pixels as perceived by the human eye, colorx stands for a wavelength of the light (e.g., in nanometers); eyed stands for a diameter of the human iris (e.g., in millimeters); and d stands for a distance between the human eye and the display area (e.g., in meters). In this example, the distance between two distinguishable pixels as perceived by the human eye is determined to be 0.001098 meters.

The pixel density can be calculated using the following formula:

$$PPI = \frac{{d}_{p}}{{d}_{i}} = \frac{\sqrt{{w}_{p}^{2} + {h}_{p}^{2}}}{{d}_{i} \times 0.0254} ;$$

wherein dₚ stands for a resolution of the display area DA along the diagonal (in pixels); wₚ stands for a horizontal resolution of the display area DA (number of pixels along the width); hₚ stands for a vertical resolution of the display area DA (number of pixels along the height); dᵢ stands a length of the diagonal of the display area DA (e.g., in inches).

In one example, wₚ is 1920, hₚ is 1080, dᵢ is 55 inches, and PPI is 1920 pixels per meter.

Using the pixel density PPI of 1920 pixels per meter and the distance between two distinguishable pixels as perceived by the human eye of 0.001098 meters, the number of pixels that determines the width of the displayed border is 1920×0.001098=2. The width of the display subarea is 2 pixels.

FIG. 17 is a schematic diagram illustrating a display area comprising a plurality of display subareas where each of the plurality of display subareas is configured to independently display a respective stream of display information. Referring to FIG. 17, with respect to a display subarea, if the shortest distance between a border of the at least one display subarea and any border of the display area that is parallel to the border of the at least one display subarea is equal to or less than the reference distance (e.g., the border of the at least one display subarea is identified as adjacent to the border of the display area that is parallel to the border of the at least one display subarea), the border of the at least one display subarea is not displayed. With respect to a display subarea, if the shortest distance between a border of the at least one display subarea and any border of the display area that is parallel to the border of the at least one display subarea is greater than the reference distance (e.g., the border of the at least one display subarea is identified as away from the border of the display area that is parallel to the border of the at least one display subarea), the border of the at least one display subarea is displayed. In FIG. 17, all borders of a central display subarea is displayed. A border of any peripheral display subarea that is adjacent to a border of the display area is not displayed.

In some embodiments, the method further includes determining a shortest distance between a border of the peripheral display subarea and any border of the central display subarea that is parallel to the border of the peripheral display subarea. In some embodiments, if a border of any peripheral display subarea is adjacent to the central display subarea SA1, the border is not displayed. In some embodiments, with respect to a peripheral display subarea, if a shortest distance between a border of the peripheral display subarea and any border of the central display subarea that is parallel to the border of the peripheral display subarea is equal to or less than a reference distance (e.g., the border of the peripheral display subarea is identified as adjacent to a border of the central display subarea that is parallel to the border of the peripheral display subarea), the border of the peripheral display subarea is not displayed. With respect to a peripheral display subarea, if a shortest distance between a border of the peripheral display subarea and any border of the central display subarea that is parallel to the border of the peripheral display subarea is greater than a reference distance (e.g., the border of the peripheral display subarea is identified as away from any border of the central display subarea that is parallel to the border of the peripheral display subarea), the border of the peripheral display subarea is displayed.

Based on the actual processed display subarea effects, the border effects can be further fine-tuned by adjusting the border width. This adjustment ensures the optimal visual experience and precision. The final outcome represents the refined border effect after this adjustment.

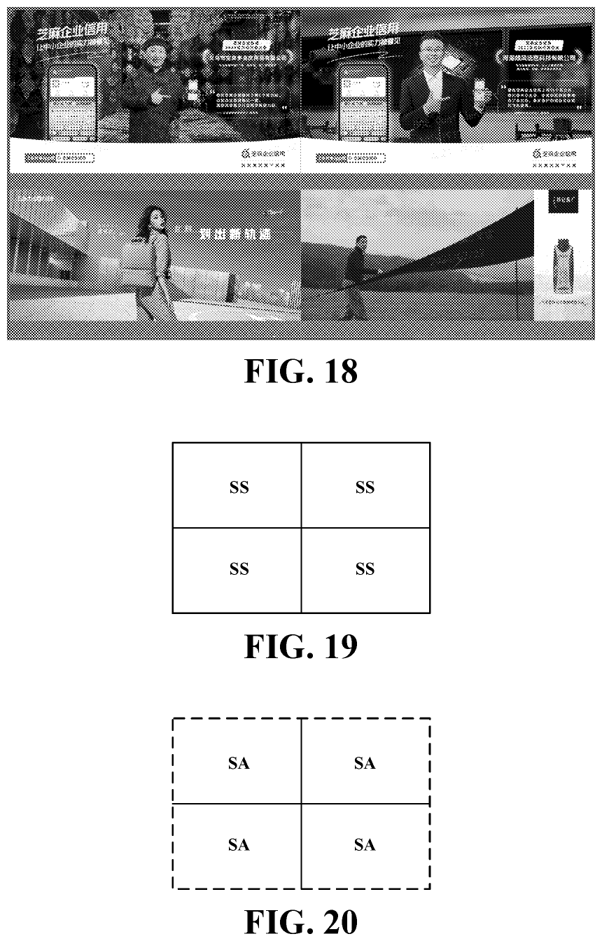

In some embodiments, the display area is divided into four quadrants using a cross-like split. In this case, the primary focus is on the image processing at the cross-shaped seams. FIG. 18 shows an example of a display area comprising a plurality of display subareas where each of the plurality of display subareas is configured to independently display a respective stream of display information.

FIG. 19 is a schematic diagram illustrating a display area comprising a plurality of display subareas where each of the plurality of display subareas is configured to independently display a respective stream of display information. Referring to FIG. 18 and FIG. 19, the display area in some embodiments is configured to receive a plurality of signal sources SS. Each of the plurality of display subareas SA is configured to independently receive a respective signal source of the plurality of signal sources SS, and independently display a respective stream of display information based on the respective signal source. A total number of the plurality of display subareas SA is four.

In one example, the wavelength of the light is 700 nanometers (blue light). The distance between the human eye and the display area is 10 meters, and the diameter of the human iris is 5 millimeters. The display area has 3840 horizontal pixels and 2160 vertical pixels, with a diagonal size of 165 inches. The human eye can distinguish two pixels at a distance of 0.003416 meters, resulting in a calculated border width of 13 pixels.

The pixel spacing H, which is the distance between two distinguishable pixels as perceived by the human eye, may be calculated as follows:

$$H = 2 \times 1.22 \times ( ( colors \times {10}^{- 9} ) / ( eyed \times 0.001 ) ) \times d ;$$

wherein H stands for the distance between two distinguishable pixels as perceived by the human eye, colorx stands for a wavelength of the light (e.g., in nanometers); eyed stands for a diameter of the human iris (e.g., in millimeters); and d stands for a distance between the human eye and the display area (e.g., in meters). In this example, the distance between two distinguishable pixels as perceived by the human eye is 0.003416 meters.

The pixel density can be calculated using the following formula:

$$PPI = \frac{{d}_{p}}{{d}_{i}} = \frac{\sqrt{{w}_{p}^{2} + {h}_{p}^{2}}}{{d}_{i} \times 0.0254} ;$$

wherein dₚ stands for a resolution of the display area DA along the diagonal (in pixels); wₚ stands for a horizontal resolution of the display area DA (number of pixels along the width); hₚ stands for a vertical resolution of the display area DA (number of pixels along the height); dᵢ stands a length of the diagonal of the display area DA (e.g., in inches).

In one example, wₚ is 3840, hₚ is 2160, dᵢ is 165 inches, and PPI is 3982 pixels per meter.

Using the pixel density PPI of 3982 pixels per meter and the distance between two distinguishable pixels as perceived by the human eye of 0.003416 meters, the number of pixels that determines the width of the displayed border is 3982×0.003416=13. The width of the display subarea is 13 pixels.

FIG. 20 is a schematic diagram illustrating a display area comprising a plurality of display subareas where each of the plurality of display subareas is configured to independently display a respective stream of display information. Referring to FIG. 20, with respect to a display subarea, if the shortest distance between a border of the at least one display subarea and any border of the display area that is parallel to the border of the at least one display subarea is equal to or less than the reference distance (e.g., the border of the at least one display subarea is identified as adjacent to the border of the display area that is parallel to the border of the at least one display subarea), the border of the at least one display subarea is not displayed. With respect to a display subarea, if the shortest distance between a border of the at least one display subarea and any border of the display area that is parallel to the border of the at least one display subarea is greater than the reference distance (e.g., the border of the at least one display subarea is identified as away from the border of the display area that is parallel to the border of the at least one display subarea), the border of the at least one display subarea is displayed. In FIG. 20, all borders of a central display subarea is displayed. A border of any display subarea that is adjacent to a border of the display area is not displayed.

Based on the actual processed display subarea effects, the border effects can be further fine-tuned by adjusting the border width. This adjustment ensures the optimal visual experience and precision. The final outcome represents the refined border effect after this adjustment.

In one aspect, the present disclosure provides a method of image display on a display panel. In some embodiments, the method includes dividing a display area of the display panel into a plurality of display subareas, a respective display subarea of the plurality of display subareas configured to independently display an image; and adding a border to at least one display subarea of the plurality of display subareas in the display area. In some embodiments, adding the border to the at least one display subarea in the display area includes retrieving information about at least one display subarea based on coordinates on the display panel; formatting display subarea information; determining coordinates of borders of the at least one display subarea; tagging the coordinates of borders of the at least one display subarea with a tag indicating whether or not the borders of the at least one display subarea is to be displayed; assigning a value to a tag indicating whether or not the border of the at least one display subarea is to be displayed; and displaying an image in the display area.

In some embodiments, the method further includes, determining a shortest distance between a border of the at least one display subarea and any border of the display area that is parallel to the border of the at least one display subarea. Optionally, the method further includes not displaying the border of the at least one display subarea upon determination that the shortest distance between the border of the at least one display subarea and any border of the display area that is parallel to the border of the at least one display subarea is equal to or less than the reference distance. Optionally, the method further includes displaying the border of the at least one display subarea upon determination that the shortest distance between the border of the at least one display subarea and any border of the display area that is parallel to the border of the at least one display subarea is greater than the reference distance.

Optionally, assigning the value to the tag indicating whether or not the border of the at least one display subarea is to be displayed includes assigning a first value to the tag indicating that the border of the at least one display subarea is not to be displayed upon determination that the shortest distance between the border of the at least one display subarea and any border of the display area that is parallel to the border of the at least one display subarea is equal to or less than the reference distance. Optionally, assigning the value to the tag indicating whether or not the border of the at least one display subarea is to be displayed includes assigning a second value to the tag indicating that the border of the at least one display subarea is to be displayed upon determination that the shortest distance between the border of the at least one display subarea and any border of the display area that is parallel to the border of the at least one display subarea is greater than the reference distance.

Optionally, the reference distance is 20 pixels.

In some embodiments, the display area comprises M rows and N columns of pixels; and the plurality of display subareas comprise a central display subarea spanning from a pixel at an (m+1)-th column and an (n+1)-th row to a pixel at an (M−m)-th column and N-th row, and multiple peripheral display subareas, wherein m, n, M, and N are positive integers, M>m, and N>n. In some embodiments, the method further includes determining a shortest distance between a border of the peripheral display subarea and any border of the central display subarea that is parallel to the border of the peripheral display subarea. Optionally, the method further includes not displaying the border of the peripheral display subarea upon determination that the shortest distance between a border of the peripheral display subarea and any border of the central display subarea that is parallel to the border of the peripheral display subarea is equal to or less than a reference distance. Optionally, the method further includes displaying the border of the peripheral display subarea upon determination that the shortest distance between the border of the peripheral display subarea and any border of the central display subarea that is parallel to the border of the peripheral display subarea is greater than the reference distance.

Optionally, the reference distance is 20 pixels.

Optionally, assigning the value to the tag indicating whether or not the border of the at least one display subarea is to be displayed includes assigning a first value to the tag indicating that the border of the peripheral display subarea is not to be displayed upon determination that the shortest distance between a border of the peripheral display subarea and any border of the central display subarea that is parallel to the border of the peripheral display subarea is equal to or less than a reference distance. Optionally, assigning the value to the tag indicating whether or not the border of the at least one display subarea is to be displayed includes assigning a second value to the tag indicating that the border of the peripheral display subarea is to be displayed upon determination that the shortest distance between the border of the peripheral display subarea and any border of the central display subarea that is parallel to the border of the peripheral display subarea is greater than the reference distance.

In some embodiments, the method further includes determining a width of a displayed border of the at least one display subarea. In some embodiments, the width of the displayed border of the at least one display subarea is determined according to:

$$pixels = 2 \times 1.22 \times ( ( colorx \times {10}^{- 9} ) / ( eyed \times 0.001 ) ) \times d \times \frac{\sqrt{{wp}^{2} + h {p}^{2}}}{di \times 0.0254} ;$$

wherein pixels stands for a number of pixels that determines the width of the displayed border; colorx stands for a wavelength of the light; eyed stands for a diameter of the human iris; d stands for a distance between the human eye and the display area; wₚstands for a horizontal resolution of the display area; hₚstands for a vertical resolution of the display area; dᵢ stands a length of the diagonal of the display area. In the above equation, 0.0254 stands for a conversion factor from inches to meters.

In some embodiments, the method further includes rounding up the number of pixels that determines the width of the displayed border to the nearest integer, thereby determining a calculated width of the displayed border.

In some embodiments, the method further includes applying the value of the width of the displayed border to the displayed border of the at least one display subarea where a second value is assigned to the tag indicating the border of the at least one display subarea is to be displayed.

In some embodiments, the method further includes performing a correction adjustment to a calculated width of the displayed border, thereby obtaining a final width of the displayed border.

In some embodiments, the display area includes M rows and N columns of pixels; and the plurality of display subareas comprise a central display subarea spanning from a pixel at an (m+1)-th column and an (n+1)-th row to a pixel at an (M−m)-th column and (N−n)-th row, and multiple peripheral display subareas surrounding the central display subarea, wherein m, n, M, and N are positive integers, M>m, and N>n.

In some embodiments, the method further includes determining a value of the wavelength of the light used in determining a width of a displayed border of the at least one display subarea. In some embodiments, determining the value of the wavelength of the light used in determining the width of the displayed border of the at least one display subarea comprises summing grayscale values of all pixels of each color component within a specified area in the display area to obtain summed grayscale values of each color component; determining a mean value for grayscale values of each color component to obtain mean grayscale values of each color component; inverting the summed grayscale values of each color component based on the mean grayscale values of each color component to obtain inverted grayscale values of each color component; and determining the value of the wavelength of the light used in determining the width of the displayed border of the at least one display subarea based on the inverted grayscale values of each color component. Optionally, determining the value of the wavelength of the light used in determining the width of the displayed border of the at least one display subarea further includes setting an inverted grayscale value to 0 if any of the inverted grayscale values of each color component is less than 0; and setting an inverted grayscale value to 255 if any of the inverted grayscale values of each color component is greater than 255. Optionally, determining the value of the wavelength of the light used in determining the width of the displayed border of the at least one display subarea further includes using a lookup table including correlations between grayscale values and corresponding wavelengths.

In another aspect, the present disclosure provides an apparatus. In some embodiments, the apparatus includes a memory; and one or more processors. Optionally, the memory and the one or more processors are connected with each other. Optionally, the memory stores computer-executable instructions for controlling the one or more processors to divide a display area of a display panel into a plurality of display subareas, a respective display subarea of the plurality of display subareas configured to independently display an image; and add a border to at least one display subarea of the plurality of display subareas in the display area. Optionally, to add the border to the at least one display subarea in the display area, the memory further stores computer-executable instructions for controlling the one or more processors to retrieve information about at least one display subarea based on coordinates on the display panel; format display subarea information; determine coordinates of borders of the at least one display subarea; tag the coordinates of borders of the at least one display subarea with a tag indicating whether or not the borders of the at least one display subarea is to be displayed; and assign a value to a tag indicating whether or not the border of the at least one display subarea is to be displayed.

In some embodiments, the memory further stores computer-executable instructions for controlling the one or more processors to determine a shortest distance between a border of the at least one display subarea and any border of the display area that is parallel to the border of the at least one display subarea; and have the display panel to display the border of the at least one display subarea upon determination that the shortest distance between the border of the at least one display subarea and any border of the display area that is parallel to the border of the at least one display subarea is greater than a reference distance.

In some embodiments, the memory further stores computer-executable instructions for controlling the one or more processors to, upon determination that the shortest distance between the border of the at least one display subarea and any border of the display area that is parallel to the border of the at least one display subarea is equal to or less than the reference distance, have the display panel not to display the border of the at least one display subarea.

In some embodiments, the memory further stores computer-executable instructions for controlling the one or more processors to assign a first value to the tag indicating that the border of the at least one display subarea is not to be displayed upon determination that the shortest distance between the border of the at least one display subarea and any border of the display area that is parallel to the border of the at least one display subarea is equal to or less than the reference distance; and assign a second value to the tag indicating that the border of the at least one display subarea is to be displayed upon determination that the shortest distance between the border of the at least one display subarea and any border of the display area that is parallel to the border of the at least one display subarea is greater than the reference distance.

In some embodiments, the reference distance is 20 pixels.

In some embodiments, the display area comprises M rows and N columns of pixels; and the plurality of display subareas comprise a central display subarea spanning from a pixel at an (m+1)-th column and an (n+1)-th row to a pixel at an (M−m)-th column and N-th row, and multiple peripheral display subareas, wherein m, n, M, and N are positive integers, M>m, and N>n.

In some embodiments, the memory further stores computer-executable instructions for controlling the one or more processors to determine a shortest distance between a border of the peripheral display subarea and any border of the central display subarea that is parallel to the border of the peripheral display subarea; and have the display panel to display the border of the peripheral display subarea upon determination that the shortest distance between the border of the peripheral display subarea and any border of the central display subarea that is parallel to the border of the peripheral display subarea is greater than a reference distance.

In some embodiments, the memory further stores computer-executable instructions for controlling the one or more processors to, upon determination that the shortest distance between a border of the peripheral display subarea and any border of the central display subarea that is parallel to the border of the peripheral display subarea is equal to or less than the reference distance, have the display panel not to display the border of the peripheral display subarea.

In some embodiments, the memory further stores computer-executable instructions for controlling the one or more processors to assign a first value to the tag indicating that the border of the peripheral display subarea is not to be displayed upon determination that the shortest distance between a border of the peripheral display subarea and any border of the central display subarea that is parallel to the border of the peripheral display subarea is equal to or less than the reference distance; and assign a second value to the tag indicating that the border of the peripheral display subarea is to be displayed upon determination that the shortest distance between the border of the peripheral display subarea and any border of the central display subarea that is parallel to the border of the peripheral display subarea is greater than the reference distance.

In some embodiments, the memory further stores computer-executable instructions for controlling the one or more processors to determine a width of a displayed border of the at least one display subarea.

In some embodiments, the width of the displayed border of the at least one display subarea is determined according to:

$$pixels = 2 \times 1.22 \times ( ( colorx \times {10}^{- 9} ) / ( eyed \times 0.001 ) ) \times d \times \frac{\sqrt{{wp}^{2} + h {p}^{2}}}{di \times 0.0254} ;$$

wherein pixels stands for a number of pixels that determines the width of the displayed border; colorx stands for a wavelength of the light; eyed stands for a diameter of the human iris; d stands for a distance between the human eye and the display area; wₚstands for a horizontal resolution of the display area; hₚstands for a vertical resolution of the display area; dᵢ stands a length of the diagonal of the display area.

In some embodiments, the memory further stores computer-executable instructions for controlling the one or more processors to round up the number of pixels that determines the width of the displayed border to the nearest integer, thereby determining a calculated width of the displayed border.

In some embodiments, the memory further stores computer-executable instructions for controlling the one or more processors to apply the value of the width of the displayed border to the displayed border of the at least one display subarea where a second value is assigned to the tag indicating the border of the at least one display subarea is to be displayed.

In some embodiments, the memory further stores computer-executable instructions for controlling the one or more processors to perform a correction adjustment to a calculated width of the displayed border, thereby obtaining a final width of the displayed border.

In some embodiments, the memory further stores computer-executable instructions for controlling the one or more processors to determine a value of the wavelength of the light used in determining a width of a displayed border of the at least one display subarea. Optionally, to determine the value of the wavelength of the light used in determining the width of the displayed border of the at least one display subarea, the memory further stores computer-executable instructions for controlling the one or more processors to sum grayscale values of all pixels of each color component within a specified area in the display area to obtain summed grayscale values of each color component; determine a mean value for grayscale values of each color component to obtain mean grayscale values of each color component; invert the summed grayscale values of each color component based on the mean grayscale values of each color component to obtain inverted grayscale values of each color component; and determine the value of the wavelength of the light used in determining the width of the displayed border of the at least one display subarea based on the inverted grayscale values of each color component.

In some embodiments, to determine the value of the wavelength of the light used in determining the width of the displayed border of the at least one display subarea, the memory further stores computer-executable instructions for controlling the one or more processors to set an inverted grayscale value to 0 if any of the inverted grayscale values of each color component is less than 0; and set an inverted grayscale value to 255 if any of the inverted grayscale values of each color component is greater than 255.

In some embodiments, to determine the value of the wavelength of the light used in determining the width of the displayed border of the at least one display subarea, the memory further stores computer-executable instructions for controlling the one or more processors to use a lookup table including correlations between grayscale values and corresponding wavelengths.

In another aspect, the present disclosure further provides a display apparatus, comprising the apparatus described herein, and a display panel connected to the apparatus. Optionally, the display panel is configured to display an image in the display area and a border of the at least one display subarea.

In another aspect, the present disclosure further provides a computer-program product. In some embodiments, the computer-program product includes a non-transitory tangible computer-readable medium having computer-readable instructions thereon, the computer-readable instructions being executable by a processor to cause the processor to perform dividing a display area of the display panel into a plurality of display subareas, a respective display subarea of the plurality of display subareas configured to independently display an image; and adding a border to at least one display subarea of the plurality of display subareas in the display area. Optionally, adding the border to the at least one display subarea in the display area comprises retrieving information about at least one display subarea based on coordinates on the display panel; formatting display subarea information; determining coordinates of borders of the at least one display subarea; tagging the coordinates of borders of the at least one display subarea with a tag indicating whether or not the borders of the at least one display subarea is to be displayed; and assigning a value to a tag indicating whether or not the border of the at least one display subarea is to be displayed.

In some embodiments, the computer-readable instructions are executable by one or more processors to cause the one or more processors to further perform dividing a display area of the display panel into a plurality of display subareas, a respective display subarea of the plurality of display subareas configured to independently display an image; and adding a border to at least one display subarea of the plurality of display subareas in the display area. Optionally, adding the border to the at least one display subarea in the display area comprises retrieving information about at least one display subarea based on coordinates on the display panel; formatting display subarea information; determining coordinates of borders of the at least one display subarea; tagging the coordinates of borders of the at least one display subarea with a tag indicating whether or not the borders of the at least one display subarea is to be displayed; and assigning a value to a tag indicating whether or not the border of the at least one display subarea is to be displayed.

In some embodiments, the computer-readable instructions are executable by one or more processors to cause the one or more processors to further perform determining a shortest distance between a border of the at least one display subarea and any border of the display area that is parallel to the border of the at least one display subarea; and displaying the border of the at least one display subarea upon determination that the shortest distance between the border of the at least one display subarea and any border of the display area that is parallel to the border of the at least one display subarea is greater than a reference distance.

In some embodiments, upon determination that the shortest distance between the border of the at least one display subarea and any border of the display area that is parallel to the border of the at least one display subarea is equal to or less than the reference distance, the border of the at least one display subarea is not displayed.

In some embodiments, assigning the value to the tag indicating whether or not the border of the at least one display subarea is to be displayed includes assigning a first value to the tag indicating that the border of the at least one display subarea is not to be displayed upon determination that the shortest distance between the border of the at least one display subarea and any border of the display area that is parallel to the border of the at least one display subarea is equal to or less than the reference distance; and assigning the value to the tag indicating whether or not the border of the at least one display subarea is to be displayed includes assigning a second value to the tag indicating that the border of the at least one display subarea is to be displayed upon determination that the shortest distance between the border of the at least one display subarea and any border of the display area that is parallel to the border of the at least one display subarea is greater than the reference distance.

In some embodiments, the reference distance is 20 pixels.

In some embodiments, the display area comprises M rows and N columns of pixels; and the plurality of display subareas comprise a central display subarea spanning from a pixel at an (m+1)-th column and an (n+1)-th row to a pixel at an (M−m)-th column and N-th row, and multiple peripheral display subareas, wherein m, n, M, and N are positive integers, M>m, and N>n.

In some embodiments, the computer-readable instructions are executable by one or more processors to cause the one or more processors to further perform determining a shortest distance between a border of the peripheral display subarea and any border of the central display subarea that is parallel to the border of the peripheral display subarea; and having the display panel to display the border of the peripheral display subarea upon determination that the shortest distance between the border of the peripheral display subarea and any border of the central display subarea that is parallel to the border of the peripheral display subarea is greater than a reference distance.

In some embodiments, upon determination that the shortest distance between a border of the peripheral display subarea and any border of the central display subarea that is parallel to the border of the peripheral display subarea is equal to or less than the reference distance, the border of the peripheral display subarea is not displayed.

In some embodiments, assigning the value to the tag indicating whether or not the border of the at least one display subarea is to be displayed includes assigning a first value to the tag indicating that the border of the peripheral display subarea is not to be displayed upon determination that the shortest distance between a border of the peripheral display subarea and any border of the central display subarea that is parallel to the border of the peripheral display subarea is equal to or less than the reference distance; and assigning the value to the tag indicating whether or not the border of the at least one display subarea is to be displayed includes assigning a second value to the tag indicating that the border of the peripheral display subarea is to be displayed upon determination that the shortest distance between the border of the peripheral display subarea and any border of the central display subarea that is parallel to the border of the peripheral display subarea is greater than the reference distance.

In some embodiments, the computer-readable instructions are executable by one or more processors to cause the one or more processors to further perform determining a width of a displayed border of the at least one display subarea.

In some embodiments, the width of the displayed border of the at least one display subarea is determined according to:

$$pixels = 2 \times 1.22 \times ( ( colorx \times {10}^{- 9} ) / ( eyed \times 0.001 ) ) \times d \times \frac{\sqrt{{wp}^{2} + h {p}^{2}}}{di \times 0.0254} ;$$

wherein pixels stands for a number of pixels that determines the width of the displayed border; colorx stands for a wavelength of the light; eyed stands for a diameter of the human iris; d stands for a distance between the human eye and the display area; wₚstands for a horizontal resolution of the display area; hₚstands for a vertical resolution of the display area; dᵢ stands a length of the diagonal of the display area.

In some embodiments, the computer-readable instructions are executable by one or more processors to cause the one or more processors to further perform rounding up the number of pixels that determines the width of the displayed border to the nearest integer, thereby determining a calculated width of the displayed border.

In some embodiments, the computer-readable instructions are executable by one or more processors to cause the one or more processors to further perform applying the value of the width of the displayed border to the displayed border of the at least one display subarea where a second value is assigned to the tag indicating the border of the at least one display subarea is to be displayed.

In some embodiments, the computer-readable instructions are executable by one or more processors to cause the one or more processors to further perform a correction adjustment to a calculated width of the displayed border, thereby obtaining a final width of the displayed border.

In some embodiments, the computer-readable instructions are executable by one or more processors to cause the one or more processors to further perform determining a value of the wavelength of the light used in determining a width of a displayed border of the at least one display subarea. Optionally, determining the value of the wavelength of the light used in determining the width of the displayed border of the at least one display subarea comprises summing grayscale values of all pixels of each color component within a specified area in the display area to obtain summed grayscale values of each color component; determining a mean value for grayscale values of each color component to obtain mean grayscale values of each color component; inverting the summed grayscale values of each color component based on the mean grayscale values of each color component to obtain inverted grayscale values of each color component; and determining the value of the wavelength of the light used in determining the width of the displayed border of the at least one display subarea based on the inverted grayscale values of each color component.

In some embodiments, the computer-readable instructions are executable by one or more processors to cause the one or more processors to further perform setting an inverted grayscale value to 0 if any of the inverted grayscale values of each color component is less than 0; and setting an inverted grayscale value to 255 if any of the inverted grayscale values of each color component is greater than 255.

In some embodiments, the computer-readable instructions are executable by one or more processors to cause the one or more processors to further perform using a lookup table including correlations between grayscale values and corresponding wavelengths.

All or some of steps of the method, functional modules/units in the system and the device disclosed above may be implemented as software, firmware, hardware, or suitable combinations thereof. In a hardware implementation, a division among functional modules/units mentioned in the above description does not necessarily correspond to the division among physical components. For example, one physical component may have a plurality of functions, or one function or step may be performed by several physical components in cooperation. Some or all of the physical components may be implemented as software executed by a processor, such as a central processing unit, a digital signal processor, or a microprocessor, or as hardware, or as an integrated circuit, such as an application specific integrated circuit. Such software may be distributed on a computer-readable storage medium, which may include a computer storage medium (or a non-transitory medium) and a communication medium (or a transitory medium). The term computer storage medium includes volatile and nonvolatile, removable and non-removable media implemented in any method or technology for storage of information, such as computer readable instructions, data structures, program modules or other data, as is well known to one of ordinary skill in the art. A computer storage medium includes, but is not limited to, RAM, ROM, EEPROM, flash memory or other memory technology, CD-ROM, Digital Versatile Disk (DVD) or other optical disk storage, magnetic cassette, magnetic tape, magnetic disk storage or other magnetic storage device, or any other medium which may be used to store desired information, and which may be accessed by a computer. In addition, a communication medium typically embodies computer readable instructions, data structures, program modules or other data in a modulated data signal such as a carrier wave or other transport mechanism, and includes any information delivery medium, as is well known to one of ordinary skill in the art.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A method of image display on a display panel, comprising:
dividing a display area of the display panel into a plurality of display subareas, a respective display subarea of the plurality of display subareas configured to independently display an image; and
adding a border to at least one display subarea of the plurality of display subareas in the display area;
wherein adding the border to the at least one display subarea in the display area comprises:
retrieving information about at least one display subarea based on coordinates on the display panel;
formatting display subarea information;
determining coordinates of borders of the at least one display subarea;
tagging the coordinates of borders of the at least one display subarea with a tag indicating whether or not the borders of the at least one display subarea is to be displayed;
assigning a value to a tag indicating whether or not the border of the at least one display subarea is to be displayed; and
displaying an image in the display area.

2. The method of claim 1, further comprising:
determining a shortest distance between a border of the at least one display subarea and any border of the display area that is parallel to the border of the at least one display subarea; and
displaying the border of the at least one display subarea upon determination that the shortest distance between the border of the at least one display subarea and any border of the display area that is parallel to the border of the at least one display subarea is greater than a reference distance.

3. The method of claim 2, wherein, upon determination that the shortest distance between the border of the at least one display subarea and any border of the display area that is parallel to the border of the at least one display subarea is equal to or less than the reference distance, the border of the at least one display subarea is not displayed.

4. The method of claim 2, wherein assigning the value to the tag indicating whether or not the border of the at least one display subarea is to be displayed includes assigning a first value to the tag indicating that the border of the at least one display subarea is not to be displayed upon determination that the shortest distance between the border of the at least one display subarea and any border of the display area that is parallel to the border of the at least one display subarea is equal to or less than the reference distance; and
assigning the value to the tag indicating whether or not the border of the at least one display subarea is to be displayed includes assigning a second value to the tag indicating that the border of the at least one display subarea is to be displayed upon determination that the shortest distance between the border of the at least one display subarea and any border of the display area that is parallel to the border of the at least one display subarea is greater than the reference distance.

5. The method of claim 2, wherein the reference distance is 20 pixels.

6. The method of claim 1, wherein the display area comprises M rows and N columns of pixels; and
the plurality of display subareas comprise a central display subarea spanning from a pixel at an (m+1)-th column and an (n+1)-th row to a pixel at an (M−m)-th column and N-th row, and multiple peripheral display subareas, wherein m, n, M, and N are positive integers, M>m, and N>n.

7. The method of claim 6, further comprising determining a shortest distance between a border of the peripheral display subarea and any border of the central display subarea that is parallel to the border of the peripheral display subarea; and
displaying the border of the peripheral display subarea upon determination that the shortest distance between the border of the peripheral display subarea and any border of the central display subarea that is parallel to the border of the peripheral display subarea is greater than a reference distance.

8. The method of claim 7, wherein, upon determination that the shortest distance between a border of the peripheral display subarea and any border of the central display subarea that is parallel to the border of the peripheral display subarea is equal to or less than the reference distance, the border of the peripheral display subarea is not displayed.

9. The method of claim 7, wherein assigning the value to the tag indicating whether or not the border of the at least one display subarea is to be displayed includes assigning a first value to the tag indicating that the border of the peripheral display subarea is not to be displayed upon determination that the shortest distance between a border of the peripheral display subarea and any border of the central display subarea that is parallel to the border of the peripheral display subarea is equal to or less than the reference distance; and
assigning the value to the tag indicating whether or not the border of the at least one display subarea is to be displayed includes assigning a second value to the tag indicating that the border of the peripheral display subarea is to be displayed upon determination that the shortest distance between the border of the peripheral display subarea and any border of the central display subarea that is parallel to the border of the peripheral display subarea is greater than the reference distance.

10. The method of claim 1, further comprising determining a width of a displayed border of the at least one display subarea.

11. The method of claim 10, wherein the width of the displayed border of the at least one display subarea is determined according to:
$$pixels = 2 \times 1.22 \times ( ( colorx \times {10}^{- 9} ) / ( eyed \times 0.001 ) ) \times d \times \frac{\sqrt{{wp}^{2} + h {p}^{2}}}{di \times 0.0254}$$
wherein pixels stands for a number of pixels that determines the width of the displayed border; colorx stands for a wavelength of the light; eyed stands for a diameter of the human iris; d stands for a distance between the human eye and the display area; wₚstands for a horizontal resolution of the display area; hₚstands for a vertical resolution of the display area; dᵢ stands a length of the diagonal of the display area.

12. The method of claim 11, further comprising rounding up the number of pixels that determines the width of the displayed border to the nearest integer, thereby determining a calculated width of the displayed border.

13. The method of claim 11, further comprising applying the value of the width of the displayed border to the displayed border of the at least one display subarea where a second value is assigned to the tag indicating the border of the at least one display subarea is to be displayed.

14. The method of claim 11, further comprising performing a correction adjustment to a calculated width of the displayed border, thereby obtaining a final width of the displayed border.

15. The method of claim 11, further comprising determining a value of the wavelength of the light used in determining a width of a displayed border of the at least one display subarea;
wherein determining the value of the wavelength of the light used in determining the width of the displayed border of the at least one display subarea comprises:
summing grayscale values of all pixels of each color component within a specified area in the display area to obtain summed grayscale values of each color component;
determining a mean value for grayscale values of each color component to obtain mean grayscale values of each color component;
inverting the summed grayscale values of each color component based on the mean grayscale values of each color component to obtain inverted grayscale values of each color component; and
determining the value of the wavelength of the light used in determining the width of the displayed border of the at least one display subarea based on the inverted grayscale values of each color component.

16. The method of claim 15, wherein determining the value of the wavelength of the light used in determining the width of the displayed border of the at least one display subarea further comprises:
setting an inverted grayscale value to 0 if any of the inverted grayscale values of each color component is less than 0; and
setting an inverted grayscale value to 255 if any of the inverted grayscale values of each color component is greater than 255.

17. The method of claim 15, wherein determining the value of the wavelength of the light used in determining the width of the displayed border of the at least one display subarea further comprises using a lookup table including correlations between grayscale values and corresponding wavelengths.

18. An apparatus, comprising:
a memory; and
one or more processors;
wherein the memory and the one or more processors are connected with each other; and
the memory stores computer-executable instructions for controlling the one or more processors to:
divide a display area of a display panel into a plurality of display subareas, a respective display subarea of the plurality of display subareas configured to independently display an image; and
add a border to at least one display subarea of the plurality of display subareas in the display area;
wherein, to add the border to the at least one display subarea in the display area, the memory further stores computer-executable instructions for controlling the one or more processors to:
retrieve information about at least one display subarea based on coordinates on the display panel;
format display subarea information;
determine coordinates of borders of the at least one display subarea;
tag the coordinates of borders of the at least one display subarea with a tag indicating whether or not the borders of the at least one display subarea is to be displayed; and
assign a value to a tag indicating whether or not the border of the at least one display subarea is to be displayed.

19. A display apparatus, comprising the apparatus of claim 18, and the display panel;
wherein the display panel is configured to display an image in the display area and a border of the at least one display subarea.

20. A computer-program product, comprising a non-transitory tangible computer-readable medium having computer-readable instructions thereon, the computer-readable instructions being executable by a processor to cause the processor to perform:
dividing a display area of the display panel into a plurality of display subareas, a respective display subarea of the plurality of display subareas configured to independently display an image; and
adding a border to at least one display subarea of the plurality of display subareas in the display area;
wherein adding the border to the at least one display subarea in the display area comprises:
retrieving information about at least one display subarea based on coordinates on the display panel;
formatting display subarea information;
determining coordinates of borders of the at least one display subarea;
tagging the coordinates of borders of the at least one display subarea with a tag indicating whether or not the borders of the at least one display subarea is to be displayed; and
assigning a value to a tag indicating whether or not the border of the at least one display subarea is to be displayed.
